(19) United States
(12) Patent Application Publication
(10) Pub. No.: US 2025/0308051 A1
(43) Pub. Date: Oct. 2, 2025

(54) SYSTEM AND METHOD FOR VISION MEASUREMENT OF OBJECT INFORMATION BASED ON DEEP LEARNING

(71) Applicants: Joon Woo Kim, Gyeonggi-do (KR); SHINJIN Mtec CO.,LTD., Gyeonggi-do (KR)

(72) Inventor: Joon Woo Kim, Gyeonggi-do (KR)

(21) Appl. No.: 19/090,896

(22) Filed: Mar. 26, 2025

(30) Foreign Application Priority Data
Mar. 29, 2024 (KR) 10-2024-0043263

(51) Int. Cl. G06T 7/60; G06T 7/55; G06T 7/70; G06T 11/00

(52) U.S. Cl. CPC G06T 7/60; G06T 7/55; G06T 7/70; G06T 11/00; G06T 2207/20081; G06T 2207/20084

(57) ABSTRACT

A system for vision measurement of object information based on deep learning includes: a virtual image generation unit configured to generate individual virtual images using model variable values of an object model that represents a shape and posture of the object; an image regeneration unit comprising an image encoder, which includes an encoding neural network trained using the model variable values and the virtual images, and an image decoder, which includes a decoding neural network trained using the model variable values and the virtual images; and an object measurement unit configured to output a measurement value for the object by using the image encoder which has been additionally fine-tuned using actual images of the object in the image regeneration unit.

### CROSS-REFERENCE TO RELATED APPLICATION

This application claims priority from Korean Patent Application No. 10-2024-0043263 filed on Mar. 29, 2024 in the Korean Intellectual Property Office, the contents of which in its entirety are herein incorporated by reference.

### FIELD

The present disclosure relates to a technology for optimizing the process of numerically modeling objects by receiving digital images of actual objects as input.

### BACKGROUND

In recent years, deep learning technology, which repeatedly optimizes data structures similar to neural networks, has been widely applied in the fields of image recognition and image generation. Among such technologies, an autoencoder provides a function that, when trained on given sample images, compresses the features of the images and then regenerates them in a way that closely resembles the original images.

Additionally, there are hardware devices called graphics processing units (GPUs), as well as programming languages that enable their use, which allow for the rapid processing of large volumes of images in fields such as computer graphics and deep learning.

Meanwhile, in fields such as manufacturing inspection or robotic applications, equipment designed to achieve specific objectives (e.g., inspecting the quality of manufactured products or obtaining coordinate values for robotic operations) by reading digital images received through a camera and measuring the shape of objects is referred to as vision measurement equipment, and a program designed to implement these functions is referred to as a vision measurement program.

However, according to the conventional technology, it was necessary to implement feature extraction corresponding to various target objects in order to obtain measurement values for the objects. The process of programming to extract features for each object requires a significant amount of time and a high level or expertise in image processing, which in turn increases the cost of implementing vision measurement programs for new types of objects.

### SUMMARY

Aspects of the present disclosure provide a system and method for vision measurement of object information based on deep learning, which can calculate the shape and posture of measurement target objects by defining variables representing the shape and posture of the objects, training a model using virtual images generated based on the variables, and subsequently performing additional fine-tuning training using actual images taken of the objects.

In one general aspect, there is provided a system for vision measurement of object information based on deep learning, including: a virtual image generation unit configured to generate individual virtual images using model variable values of an object model that represents a shape and posture of the object; an image regeneration unit comprising an image encoder, which includes an encoding neural network trained using the model variable values and the virtual images, and an image decoder, which includes a decoding neural network trained using the model variable values and the virtual images; and an object measurement unit configured to output a measurement value for the object by using the image encoder which has been additionally fine-tuned using actual images of the object in the image regeneration unit.

The image encoder may be configured such that the encoding neural network is trained to output each of the model variable values corresponding to the virtual images by using the virtual images as input information.

The image decoder may be configured such that the decoding neural network is trained to output each of the virtual images corresponding to the model variable values by using the model variable values as input information.

The image regeneration unit may be configured such that output information of the image encoder is combined to serve as input information of the image decoder and the image encoder is additionally fine-tuned so that an image similar to an actual image is output when the actual image is input.

The image regeneration unit may be configured such that decoding layer parameter values constituting the decoding neural network are fixed, while the encoding layer parameter values constituting the encoding neural network are set to change.

The object measurement unit may include an optimized encoder configured to obtain encoding layer parameter values from the image regeneration unit trained using the actual images of the object; and an object measurement module configured to output the measurement value for the object using the model variable value corresponding to output information of the optimized encoder.

In another general aspect, there is provided a method for vision measurement of object information based on deep learning, including: generating, at a virtual image generation unit, individual virtual images using model variable values of an object model that represents a shape and posture of the object; training an image encoder and an image decoder using the model variable values and the virtual images through a deep learning method; performing, at an image regeneration unit in which output information of the image encoder is used as input information of the image decoder, additional fine-tuning training of an encoding neural network of the image encoder within the image regeneration unit using actual images of the object; and outputting a measurement value for the object by using the additionally fine-tuned image encoder.

In the training of the image encoder, the encoding neural network may be trained to output each of the model variable values corresponding to the virtual images by using the virtual images as input information.

In the training of the image decoder, a decoding neural network may be trained to output each of the virtual images corresponding to the model variable values by using the model variable values as input information.

In the performing of the additional fine-tuning training of the encoding neural network, output information of the image encoder may be combined to serve as input information for the image decoder and the image encoder may be additionally fine-tuned so that an image similar to an actual image is output when the actual image is input.

In the performing of the additional fine-tuning training of the encoding neural network, decoding layer parameter values constituting the decoding neural network may be fixed, while the encoding layer parameter values constituting the encoding neural network may be set to change.

In the outputting of the measurement value for the object, the measurement value for the object may be output using the model variable value corresponding to output information of the additionally fine-tuned image encoder.

### Effects of the Invention

According to the present disclosure, in the field of vision measurement, which numerically represents the shape and posture of objects, the design of dependent programs based on the shape diversity of objects and the coding process for extracting object features can be minimized as much as possible, and by training with virtual images that represent various shapes and postures of new objects, and preferably, simply by performing additional training using the obtainable number of actual images of the corresponding objects to improve measurement accuracy, it becomes possible to derive the shapes and postures of objects appearing in images captured thereafter in real-world applications.

Accordingly, when the present disclosure is applied, once the object model structure representing the objects is defined, the model variable value corresponding to an input image can be automatically derived according to a deep learning process. As a result, measurement values for the objects can be easily output.

In addition, according to the present disclosure, the image processing process for extracting features specific to an object can be omitted, and the measurement value of the object can be derived simply by generating virtual images of the object and training with them. This eliminates the need for time and expertise required for image processing programming for extracting features of the object.

Additionally, in conventional methods, the degree to which noise affects measurement varies depending on the robustness of the feature extraction algorithm. However, by applying the present disclosure, even developers without traditional image processing programming skills can perform noise-robust object measurement with the aid of widely available deep learning optimization algorithms.

According to the present disclosure, the system and method can be utilized in vision inspection in industrial sites to obtain shape and posture information for new objects through large-scale data training, as well as in various robotic vision functions.

### BRIEF DESCRIPTION OF THE DRAWINGS

FIG. 1 is a block diagram illustrating an embodiment of a system for vision measurement of object information based on deep learning, according to the present disclosure.

FIG. 2 is a reference diagram for describing the specific functions of an image regeneration unit shown in FIG. 1.

FIG. 3 is a reference diagram illustrating specific hardware resources of an object measurement unit shown in FIG. 1.

FIG. 4 is a flowchart illustrating an embodiment of a method for vision measurement of object information based on deep learning, according to the present disclosure.

### DETAILED DESCRIPTION

Hereinafter, exemplary embodiments of the present invention will be described in detail with reference to the accompanying drawings.

The embodiments of the present invention are provided to more completely explain the present invention to one of ordinary skill in the art. The embodiments of the present invention may be changed in a variety of shapes, and the scope of the present invention is not limited to the following embodiments. Rather, these embodiments are provided to make the present disclosure more substantial and complete and to completely transfer the concept of the present invention to those skilled in the art.

The terms used herein are to explain particular embodiments and not intended to limit the present invention. As used herein, singular forms may include plural forms unless particularly defined otherwise in context. Also, as used herein, the term “and/or” includes any and all combinations or one of a plurality of associated listed items.

The present disclosure relates to a technology that extracts information regarding objects by receiving images captured by a camera as input to a computer, and pertains to a vision measurement technology for extracting information on the shape and posture of objects as accurately as possible in numerical terms. In contrast to the present disclosure, conventional vision measurement methods have generally been carried out through the following procedures.

First, in a design process, 1) defining a feature data structure for features (e.g., vertices, boundaries, and specific shapes) of objects, 2) defining the process for deriving the feature data from an image, and 3) designing the process for deriving the shape and posture of objects based on the feature data are performed. Then, in an implementation process, 1) implementing code for extracting the features of objects and deriving feature data, 2) implementing code for deriving the shape and posture of objects from the feature data, and 3) implementing the overall vision measurement program code using the above codes are performed. Thereafter, as a new object adaptation process, the design and implementation processes above are repeated. However, all these processes must be redesigned and reimplemented whenever the shape of the target objects changes, which requires a significant amount of time and effort.

The present disclosure relates to a vision measurement technology designed to improve upon these drawbacks, and may be implemented through the following processes.

First, in a design process, the following are performed: 1) defining a data structure of an “object model” that represents the shape and posture of objects, 2) defining an encoder network that receives an image as input and outputs an object model, and 3) defining a decoder network that receives the object model as input and outputs an image.

Next, in an implementation process, the following are performed: 1) implementing graphics program code that generates virtual images using object model variable values, 2) implementing program code for training the encoder network, 3) initially optimizing the encoder network by randomly training it with object models and virtual images created with the models, 4) implementing program code for training the decoder network, 5) optimizing the decoder network by randomly training it with object models and virtual images created with the models, 6) implementing program code for training the entire autoencoder network, which combines the encoder and decoder components, 7) performing additional fine-tuning training of the entire autoencoder network, which combines the initially trained encoder and the fully trained decoder, by using actual images of the objects as both input and output, thereby finally optimizing the encoder network, and 8) implementing the entire vision measurement program code using the optimized encoder part.

Thereafter, in a new object adaptation process, the following are performed: 1) defining the object model in the design phase, 2) modifying only the object model layer-related part in the encoder network from the design phase, 3) modifying only the object model layer-related part in the decoder network from the design phase, 4) implementing the virtual image graphics program code in the implementation phase, 5) performing decoder training in the implementation phase, 6) performing initial training of encoder in the implementation phase, and 7) performing additional fine-tuning training of autoencoder for the final optimization of the encoder in the implementation phase.

According to the present disclosure, developers do not need to implement an algorithm for extracting features of objects from images, thereby removing entry barriers associated with a developer's level of expertise in image processing while also significantly reducing redevelopment costs for adapting to objects of new shapes.

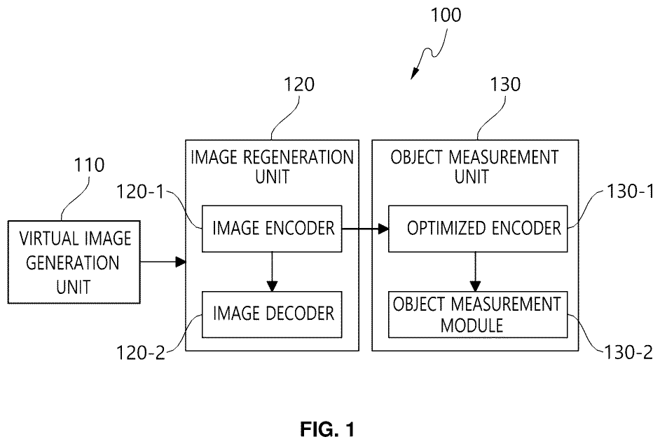

FIG. 1 is a block diagram illustrating an embodiment of a system 100 for vision measurement of object information based on deep learning, according to the present disclosure.

Referring to FIG. 1, the system 100 includes a virtual image generation unit 110, an image regeneration unit 120, and an object measurement unit 130. However, when measurement is performed solely using an optimized encoder that has completed training, it is sufficient for only the object measurement unit 130 to be placed at the measurement location for operation.

The virtual image generation unit 110 generates individual virtual images using model variable values of an object model that represents the shape and posture of the object. The virtual image generation unit 110 is equipped with graphics program code that generates virtual images using model variable values of a predefined object model. Accordingly, the virtual image generation unit 110 may generate virtual images corresponding to the object model by utilizing the graphics program code, in which the model variable values of the object model are used as input information.

Here, the model variable values, i.e., the data structure, of the object model, may be freely defined according to the shape of the object. For example, in case that the object is of a two-dimensional rectangular shape, the rectangular object may be defined using model variable values such as the coordinates of the center, the length of the long and short sides, and the rotation angle. If there are multiple rectangles, the rectangular objects may be defined based on the number of rectangles and their respective model variable values, such as the coordinates of the center, the length of the long and short sides, and the rotation angle, as described above. Additionally, even if the background or color of the object changes, the object may also be defined as a model variable value.

The virtual image generation unit 110 supports high-speed graphics processing unit (GPU)-based rendering, such as OpenGL or DirectX, to randomly generate virtual images corresponding to the model variables of the object model.

The image regeneration unit 120 includes an image encoder 120-1 and an image decoder 120-2, which are trained using model variable values and corresponding virtual images.

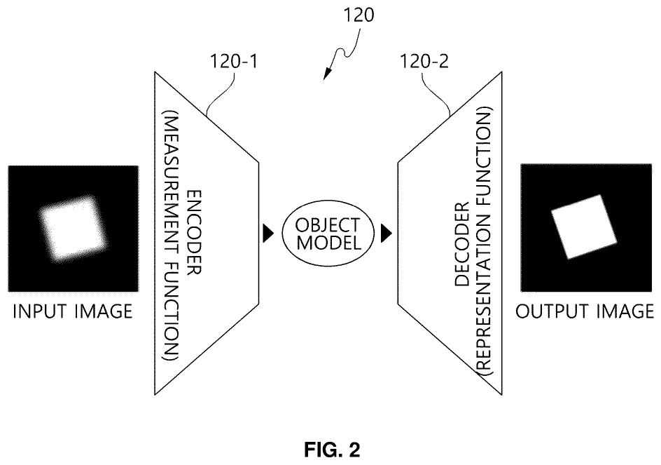

FIG. 2 is a reference diagram for describing the specific functions of the image regeneration unit 120 shown in FIG. 1.

The image encoder 120-1 includes an encoding neural network for deep learning. The encoding neural network is an artificial neural network trained using the virtual images generated by the virtual image generation unit 110 as input information and the model variable values of the predefined object model as output information.

The input layer of the encoding neural network must match the size of each virtual image, while the output layer must match the data size of the model variable values. Accordingly, the output information is significantly smaller than the input information. The input information is three-dimensional information in the form of channel×height×width, whereas the output information corresponds to one-dimensional information in which the model variable values of the object model are arranged in a row. The number of intermediate layers in the encoding neural network, the number of nodes, and the arrangement of activation functions may vary and are not particularly limited.

The encoding neural network of the image encoder 120-1 may be trained using tens of thousands or more pairs of training data, where each pair of training data consists of a virtual image as input information and its corresponding model variable values as output information. The image encoder 120-1 may be trained using a GPU-based graphics function.

The image decoder 120-2 includes a decoding neural network for deep learning. The decoding neural network is an artificial neural network trained using model variable values of the predefined object model as input information and the virtual images generated by the virtual image generation unit 110 as output information.

The input layer of the decoding neural network must match the data size of the model variable values, while the output layer must match the size of each virtual image. Accordingly, the input information corresponds to one-dimensional information, in which the model variable values of the object model are arranged in a row, whereas the output information corresponds to three-dimensional information in the form of channel×height×width. The number of intermediate layers in the decoding neural network, the number of nodes, and the arrangement of activation functions may vary and are not particularly limited.

The decoding neural network of the image decoder 120-2 may be trained using tens of thousands or more pairs of training data, where each pair consists of model variable values as input information and their corresponding virtual image as output information. The image decoder 120-2 may be trained using a GPU-based graphics function.

The neural networks of each of the image encoder 120-1 and the image decoder 120-2 of the image regeneration unit 120 are trained using the virtual images. Afterwards, the two components are combined such that the model variable values of the object model corresponding to the output information of the image encoder 120-1 become the input information of the image decoder 120-2, and in this state, additional fine-tuning training may be performed using actual images as both the input and output.

Once the initial training is completed, the decoding layer parameter values constituting the decoding neural network inside the image regeneration unit 120 may be fixed, while only the encoding layer parameter values constituting the encoding neural network may be set to change.

By fixing the decoding layer parameter values of the image decoder 120-2 and allowing only the encoding layer parameter values of the image encoder 120-1 to change, the optimization according to the deep-learning training of the image regeneration unit 120 may be conducted exclusively on the image encoder 120-1. This is to ensure that the form of the output information generated by the image encoder 120-1, specifically, the model variable values of the object model, is not distorted by additional training for the optimization of the image decoder 120-2.

With the image encoder 120-1 and image decoder 120-2 combined, the image regeneration unit 120 may perform additional fine-tuning training by using actual images of objects taken in real-world conditions as both input information and output information. This allows the image encoder 120-1 to be optimized while keeping the image decoder 120-2 fixed.

Here, the actual images may be captured in various postures under various conditions, and a sufficient number of images may be acquired for training. In principle, the required number of actual images increases exponentially proportional to the size of the object model data. However, since the initial training with virtual images has already achieved a rough global optimization that allows for basic tracking of the object's shape and posture, it is sufficient to acquire actual images that enable learning of image noise and obstacles.

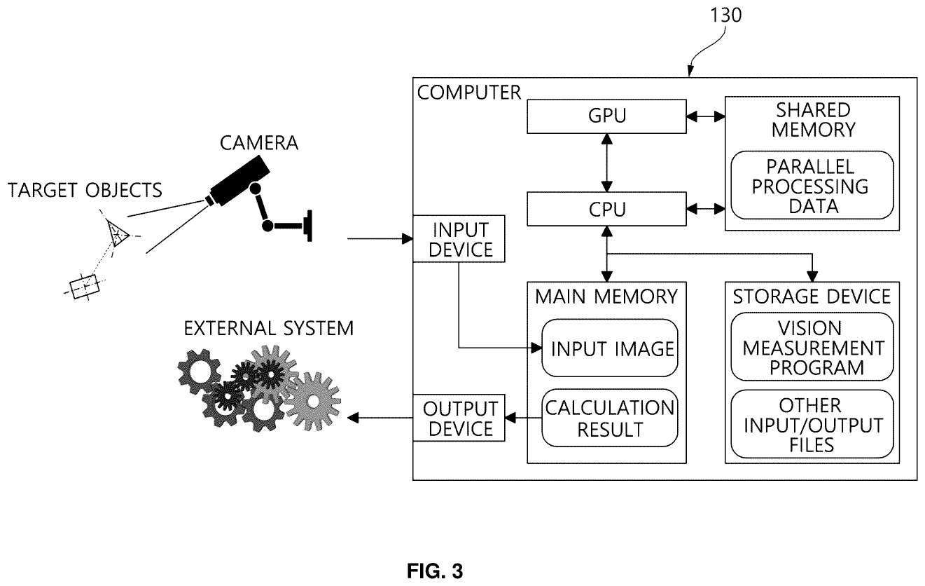

The object measurement unit 130 calculates measurement data for the object using an optimized encoder that has been additionally fine-tuned using the actual images of the object. To this end, the object measurement unit 130 includes the optimized encoder 130-1 and an object measurement module 130-2. FIG. 3 is a reference diagram illustrating specific hardware resources of the object measurement unit 130.

The optimized encoder 130-1 is the result of optimizing the image encoder 120-1, which constitutes image regeneration unit 120, through training. In other words, the optimized encoder 130-1 is an encoder that has received the layer parameter values of the image encoder, which has been additionally fine-tuned by inputting actual images instead of virtual images into the image regeneration unit 120.

The image encoder 120-1 of the image regeneration unit 120 is trained using the actual images as both input information and output information, and through this training, the encoding layer parameter values of the image encoder 120-1 are optimized. The optimized encoder 130-1 may be implemented by separating and storing the file of the optimized encoder 120-1 separately. The optimized encoder 130-1 uses the actual images as input information and outputs the model variable values corresponding to the object model.

The object measurement module 130-2 outputs individual measurement values for the object based on the model variable values of the object model, which correspond to the output information of the optimized encoder 130-1. Specifically, the object measurement module 130-2 receives new images of a target object to be measured, and by using the model variable values corresponding to the object model obtained from the optimized encoder 130-1, it calculates measurement results.

The object measurement module 130-2 may include program code for outputting the desired measurement data from the object model. For example, if the output information of the optimized encoder 130-1 corresponds to the center coordinates of a two-dimensional rectangular object, the lengths of its long and short sides, and its rotation angle, and the information to be measured is the area of the rectangle, the object measurement module 130-2 calculates and outputs the measurement value by multiplying the lengths of the long and short sides of the rectangle.

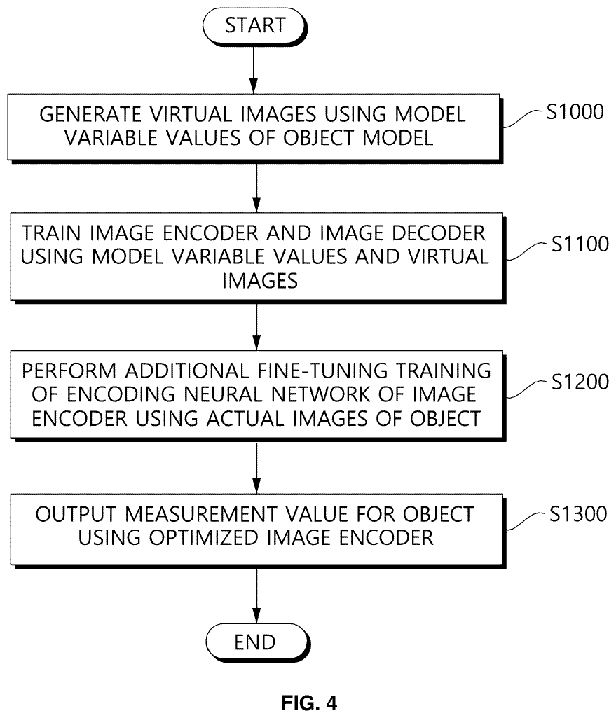

FIG. 4 is a flowchart illustrating an embodiment of a method for vision measurement of object information based on deep learning, according to the present disclosure.

First, a virtual image generation unit repeatedly generates virtual images using model variable values of an object model that represents the shape and posture of an object (step S1000).

A virtual image generation unit is equipped with graphics program code that generates virtual images using model variable values of a predefined object model. Accordingly, the virtual image generation unit may generate virtual images corresponding to the object model using the graphics program code.

After step S1000, an image encoder and an image decoder are trained using the model variable values and the virtual images through a deep learning method (step S1100).

The image encoder trains an encoding neural network so that it outputs each of the model variable values corresponding to the virtual images by using the virtual images as input information. The image encoder includes an encoding neural network for deep learning. The encoding neural network is trained using the virtual images generated by the virtual image generation unit 110 as input information and the model variable values of the predefined object model as output information. The input layer of the encoding neural network matches the size of each virtual image, while the output layer matches the data size of the model variable values.

The encoding neural network of the image encoder may be trained using tens of thousands or more pairs of training data, where each pair of training data consists of a virtual image as input information and its corresponding model variable values as output information.

Additionally, the image decoder may train a decoding neural network so that it outputs each of the virtual images corresponding to the model variable values by using the model variable values as input information. The image decoder includes the decoding neural network for deep learning. The decoding neural network is trained using model variable values of the predefined object model as input information and the virtual images generated by the virtual image generation unit as output information.

The input layer of the decoding neural network matches the data size of the model variable values, while the output layer matches the size of each virtual image. The number of intermediate layers in the decoding neural network, the number of nodes, and the arrangement of activation functions may vary and are not particularly limited.

The decoding neural network of the image decoder may be trained using tens of thousands or more pairs of training data, where each pair consists of model variable values as input information and their corresponding virtual image as output information.

After step S1100, the image regeneration unit, in which the output information of the image encoder is used as input information of the image decoder, performs additional fine-tuning training of the image encoder within the image regeneration unit using actual images of the object (step S1200).

The image regeneration unit may be configured such that the output information of the image encoder is combined to serve as input information of the image decoder. The image regeneration unit may be configured such that decoding layer parameter values constituting the decoding neural network are fixed, while the encoding layer parameter values constituting the encoding neural network are set to change.

By fixing the decoding layer parameter values of the image decoder and allowing only the encoding layer parameter values of the image encoder to change, the intermediate data values are ensured to retain the form corresponding to the model variable values of the object, and the optimization according to the deep learning training of the image regeneration unit may be conducted exclusively on the image encoder.

With the image encoder and image decoder combined, the image regeneration unit may be trained by using actual images of objects taken in real-world conditions as both input information and output information. This allows the image encoder to be optimized while keeping the image decoder fixed.

After step S1200, the image encoder, which has been additionally fine-tuned and optimized, is used to output a measurement value for the object (step S1300).

The step of outputting the measurement value for the object involves using the object model, which corresponds to the output information of the image encoder trained using actual images of the object, to output the measurement value for the object.

The image encoder of the image regeneration unit is trained using the actual images as both input and output information, and through this training, the encoding layer parameter values of the image encoder are optimized. An optimized encoder may be implemented by separating and storing the file of the optimized encoder separately, and the optimized encoder uses the actual images as input information and outputs the model variable values corresponding to the object model.

Subsequently, the object measurement module outputs individual measurement values for the object based on the model variable values of the object model, which correspond to the output information of the optimized encoder. The object measurement module may include program code for outputting the desired measurement data from the object model. For example, if the output information of the optimized encoder corresponds to the center coordinates of a two-dimensional rectangular object, the lengths of its long and short sides, and its rotation angle, and the information to be measured is the area of the rectangle, the object measurement module calculates and outputs the measurement value by multiplying the lengths of the long and short sides of the rectangle.

The process of adapting the system 100 for vision measurement of object information based on deep learning, which is implemented according to the present disclosure, to a new object is as follows.

1) First, in the process of defining an object model, the structure of an object model for representing new objects is defined.

2) Next, in the process of modifying an object model layer-related part for the image decoder, the structure of the decoder network is adjusted to match the size of the object model, which is the input to the image decoder, and the layers and scale of the nodes connected afterward are appropriately modified. If necessary, the size of the intermediate layers may be automatically determined based on the input and output scales, in which case the manual modification of the network may be omitted.

3) Next, in the process of modifying the object model layer-related part for the image encoder, the structure of the encoder network is adjusted to match the size of the object model, which is the output of the image encoder, and the layers and scale of the nodes connected earlier are also appropriately modified. If necessary, the size of the intermediate layers may be automatically determined based on the input and output scales, in which case the manual modification of the network may be omitted.

4) Subsequently, in the process of implementing the virtual image graphics program code, graphics program code is implemented to render new objects as virtual images.

5) Next, in the process of training the image decoder and performing the initial training of the image encoder, the structure-modified neural networks of the image decoder and image encoder are trained using pairs of model variable values and virtual images generated by the virtual image generation unit.

6) Next, in the process of training the entire autoencoder of the image regeneration unit for optimizing the image encoder, files which store layer parameter values of the trained image decoder and the initially trained image encoder are loaded into the image decoder and image encoder inside the image regeneration unit, and subsequently, additional fine-tuning training is performed using actual images of the new objects as both input and output. In the finalized network, the layer parameter values of the encoder part in the front are stored as a file, which may then be loaded into the optimized encoder of the object measurement unit embedded in the object information measurement system for use.

As described above, in the field of vision measurement, which numerically represents the shape and posture of objects, the design of dependent programs based on the shape diversity of objects and the coding process for extracting object features may be minimized as much as possible, and simply by training with virtual images that represent various shapes and postures of new objects and the obtainable number of actual images of the objects for additional fine-tuning, it becomes possible to output the shapes and postures of objects appearing in images captured later in real-world application situations.

Each of the methods according to embodiments of the present invention may be embodied as a program instruction executable through various computer means and may be recorded in a computer-readable medium. The computer-readable medium may include one or a combination of a program instruction, a data file, a data structure and the like. The program instruction recorded in the computer-readable medium may be particularly designed and configured for the present invention or may be well-known to those skilled in the art with respect to computer software to be available. The computer-readable medium, for example, includes a hardware device particularly configured to store and perform a program instruction, such as a read-only memory (ROM), a random-access memory, a flash memory and the like. The program instruction, for example, includes not only a machine language code manufactured by a compiler but also a high-level language code executable by a computer using an interpreter and the like. The hardware device described above may be configured to operate as at least one software module for performing the operations of the present invention and an inverse thereof is available.

While the present disclosure is described mainly based on the above embodiments but is not limited thereto, it will be understood by those skilled in the art that various changes and modifications are made without departing from the spirit and scope of the present invention. For example, each component specifically shown in the embodiments may be modified and implemented. It should be interpreted that differences relating to such modifications and application are included in the scope of the present invention defined in the appended claims.

### REFERENCE NUMERALS

100: SYSTEM FOR VISION MEASUREMENT OF OBJECT INFORMATION BASED ON DEEP LEARNING
110: VIRTUAL IMAGE GENERATION UNIT
120: IMAGE REGENERATION UNIT
130: OBJECT MEASUREMENT UNIT

What is claimed is:

1. A system for vision measurement of object information based on deep learning, comprising:
a virtual image generation unit configured to generate individual virtual images using model variable values of an object model that represents a shape and posture of the object;
an image regeneration unit comprising an image encoder, which includes an encoding neural network trained using the model variable values and the virtual images, and an image decoder, which includes a decoding neural network trained using the model variable values and the virtual images; and
an object measurement unit configured to output a measurement value for the object by using the image encoder which has been additionally fine-tuned using actual images of the object in the image regeneration unit.

2. The system of claim 1, wherein the image encoder is configured such that the encoding neural network is trained to output each of the model variable values corresponding to the virtual images by using the virtual images as input information.

3. The system of claim 1, wherein the image decoder is configured such that the decoding neural network is trained to output each of the virtual images corresponding to the model variable values by using the model variable values as input information.

4. The system of claim 1, wherein the image regeneration unit is configured such that output information of the image encoder is combined to serve as input information of the image decoder and the image encoder is additionally fine-tuned so that an image similar to an actual image is output when the actual image is input.

5. The system of claim 1, wherein image regeneration unit is configured such that decoding layer parameter values constituting the decoding neural network are fixed, while the encoding layer parameter values constituting the encoding neural network are set to change.

6. The system of claim 1, wherein the object measurement unit comprises:
an optimized encoder configured to obtain encoding layer parameter values from the image regeneration unit trained using the actual images of the object; and
an object measurement module configured to output the measurement value for the object using the model variable value corresponding to output information of the optimized encoder.

7. A method for vision measurement of object information based on deep learning, comprising:
generating, at a virtual image generation unit, individual virtual images using model variable values of an object model that represents a shape and posture of the object;
training an image encoder and an image decoder using the model variable values and the virtual images through a deep learning method;
performing, at an image regeneration unit in which output information of the image encoder is used as input information of the image decoder, additional fine-tuning training of an encoding neural network of the image encoder within the image regeneration unit using actual images of the object; and
outputting a measurement value for the object by using the additionally fine-tuned image encoder.

8. The method of claim 7, wherein in the training of the image encoder, the encoding neural network is trained to output each of the model variable values corresponding to the virtual images by using the virtual images as input information.

9. The method of claim 7, wherein in the training of the image decoder, a decoding neural network is trained to output each of the virtual images corresponding to the model variable values by using the model variable values as input information.

10. The method of claim 7, wherein in the performing of the additional fine-tuning training of the encoding neural network, output information of the image encoder is combined to serve as input information for the image decoder and the image encoder is additionally fine-tuned so that an image similar to an actual image is output when the actual image is input.

11. The method of claim 7, wherein in the performing of the additional fine-tuning training of the encoding neural network, decoding layer parameter values constituting the decoding neural network are fixed, while the encoding layer parameter values constituting the encoding neural network are set to change.

12. The method of claim 7, wherein in the outputting of the measurement value for the object, the measurement value of the object is output using the model variable value corresponding to output information of the additionally fine-tuned image encoder.
